(19) United States
(12) Patent Application Publication
(10) Pub. No.: US 2025/0249794 A1
(43) Pub. Date: Aug. 7, 2025

(54) RECREATIONAL VEHICLE SEATING SYSTEM AND METHOD OF USE

(71) Applicant: Premier Products, Inc., Marlton, NJ (US)

(72) Inventors: David Slater, Elkhart, IN (US); Eric Alpert, Marlton, NJ (US)

(21) Appl. No.: 19/048,253

(22) Filed: Feb. 7, 2025

Related U.S. Application Data
(60) Provisional application No. 63/550,694, filed on Feb. 7, 2024.

(51) Int. Cl. B60N 2/02; B60N 2/12; B60N 2/14; B60N 2/28; B60R 22/26

(52) U.S. Cl. CPC B60N 2/02246; B60N 2/12; B60N 2/14; B60N 2/2893; B60R 22/26; B60N 2002/0212; B60N 2002/0216; B60N 2002/022; B60R 2022/266

(57) ABSTRACT

A bench seat system for use in a recreational vehicle, luxury van, or similar vehicle types. The bench seat includes two separately independent chairs which can each slide forward or rearward independently as desired. Each chair has a pair of child safety latch anchors built into the frame of the chairs. The chair furthest from the wall surface of the vehicle is also capable of sliding horizontally on a separate track assembly, allowing for more individual space in the seats. This accounts for car seats that may use the child restraint harnesses or simply to allow for more room for passengers within those seats. Each of the two chairs is also fitted with anchors for providing a three-point anchored seatbelt. Each chair can independently recline or be laid forward for additional storage space. An embodiment could rotate both chairs simultaneously by ninety degrees (90°).

### CROSS-REFERENCE TO RELATED APPLICATION

This application claims priority in U.S. Provisional Patent Application No. 63/550,694 Filed Feb. 7, 2024, which is incorporated herein by reference.

### BACKGROUND OF THE INVENTION

### 1. Field of the Invention

The present invention relates generally to a seating system for a vehicle and a method for use thereof, and more specifically to an adjustable bench seat system for use in a recreational vehicle, van, or the like.

### 2. Description of the Related Art

Luxury vans and recreational vehicles are often outfitted with bench seats for use during travel. These seats historically have not been manufactured to include child restraint devices, and historically have limited adjustability. What is needed is a highly adjustable bench seat system for use in such vehicles with integrated child safety anchors.

Heretofore there has not been available a system or method for bench seats used in recreational vehicles, vans, or the like with the advantages and features of the present invention.

### BRIEF SUMMARY OF THE INVENTION

The present invention generally provides a bench seat system for use in a recreational vehicle, luxury van, or similar vehicle types. The bench seat includes two separately independent seats which can each slide forward or rearward independently as desired. Each seat has a pair of child safety latch anchors built into the frame of the seats. The seat furthest from the wall surface of the vehicle is also capable of sliding horizontally on a separate track assembly, allowing for more individual space in the seats. This accounts for car seats that may use the child restraint harnesses or simply to allow for more room for passengers within those seats.

Each seat can recline manually or could be powered using a motor.

Each of the seats includes integrated three-point shoulder belts.

Each of the seats can be manually or power-controlled to bend forward for additional storage, such as animal crates, luggage, etc.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention shown in a first, upright and adjacent orientation.

FIG. 2 is a three-dimensional isometric view thereof from an alternate angle.

FIG. 3 is a front elevational view thereof.

FIG. 4 is a rear elevational view thereof.

FIG. 5 is a right-side elevational view thereof.

FIG. 6 is a left-side elevational view thereof.

FIG. 7 is a partially-exploded three-dimensional isometric view thereof, showing how a right seat element can be repositioned to a second, separated orientation.

FIG. 8 is a partially-exploded three-dimensional isometric view thereof from an alternate angle.

FIG. 9 is a partially-exploded three-dimensional isometric view thereof from yet another alternate angle.

FIG. 10 is a partially-exploded three-dimensional isometric view showing how a left seat element can be repositioned to a third, slid forward or backward orientation.

FIG. 11 is a partially-exploded three-dimensional isometric view thereof from an alternate angle.

FIG. 12 is a partially-exploded three-dimensional isometric view showing how the seat element can be repositioned to a third, slid forward or backward orientation.

FIG. 13 is a partially-exploded three-dimensional isometric view thereof from an alternate angle.

FIG. 14 is a three-dimensional isometric view showing how the right seat element can be repositioned to a fourth, laid back orientation.

FIG. 15 is a three-dimensional isometric view showing how the left seat element can be repositioned to the fourth, laid-back orientation.

FIG. 16 is a right-side elevational view of the embodiment of FIG. 14.

FIG. 17 is a right-side elevational view thereof showing the left seat in a fifth, laid-forward orientation.

FIG. 18 is a three-dimensional isometric view of an alternative embodiment of the present invention from a first angle.

FIG. 19 is a three-dimensional isometric view thereof from a second angle.

FIG. 20 is a three-dimensional isometric view thereof from a third, rearward angle.

FIG. 21 is a front elevational view thereof.

FIG. 22 is a rear elevational view thereof.

FIG. 23 is a top plan view thereof.

FIG. 24 is a right-side elevational view thereof.

FIG. 25 is a left-side elevational view thereof.

FIG. 26 is a partially-exploded three-dimensional isometric view thereof showing seat elements in a first, forward facing orientation.

FIG. 27 is a partially-exploded three-dimensional isometric view thereof showing the seat elements in a second, right-facing orientation.

FIG. 28 is a three-dimensional isometric view thereof shown assembled.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Bench Seat System 2

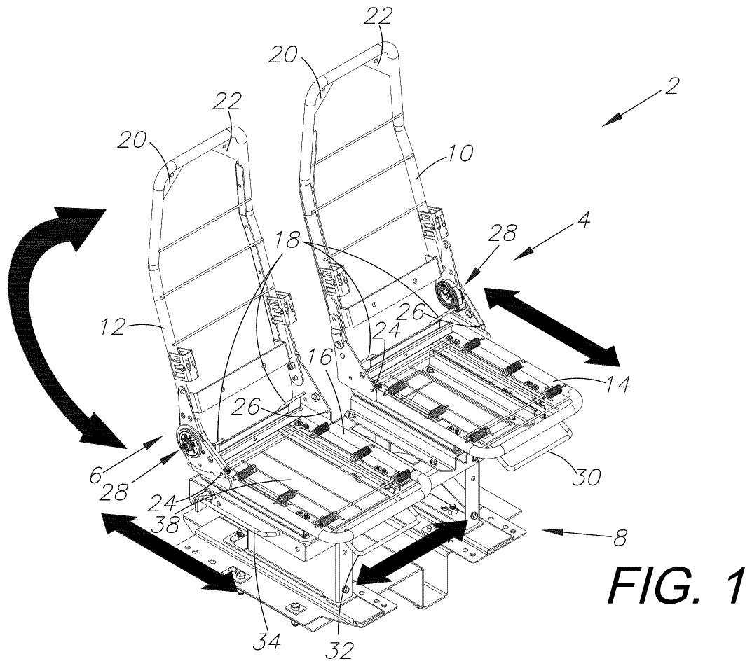

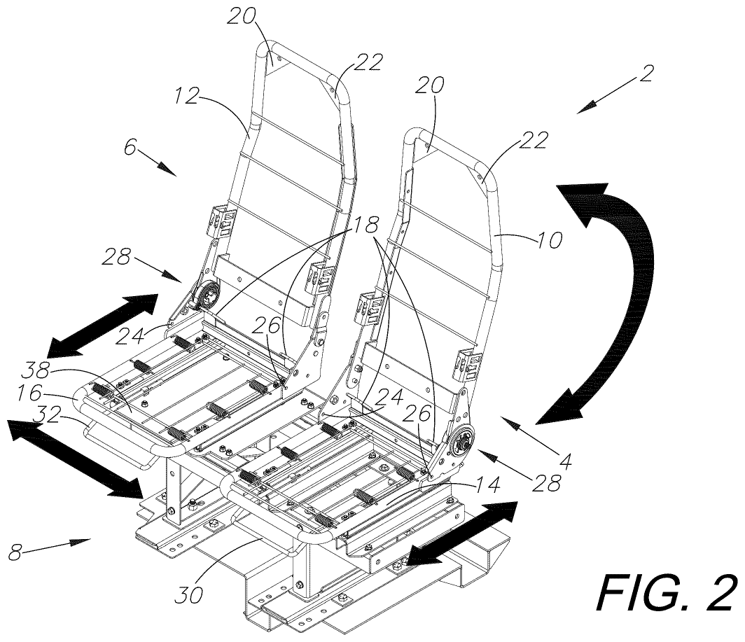

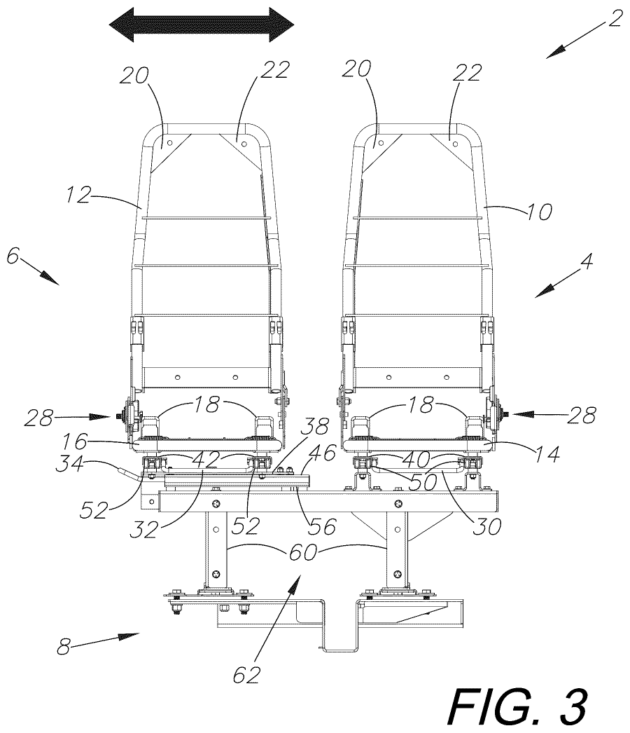

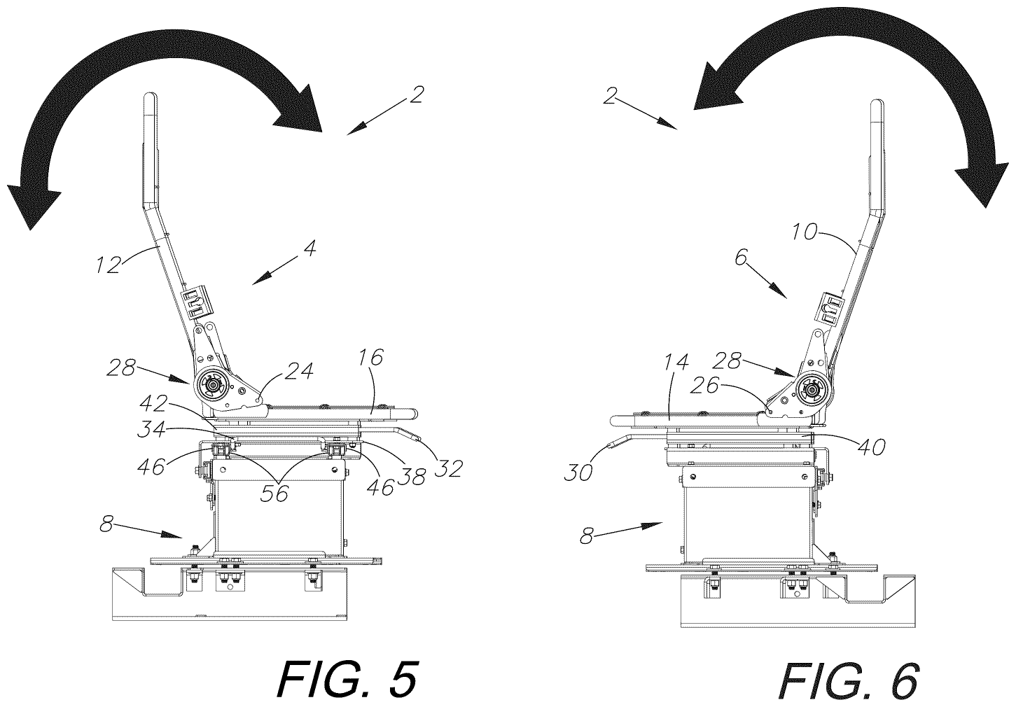

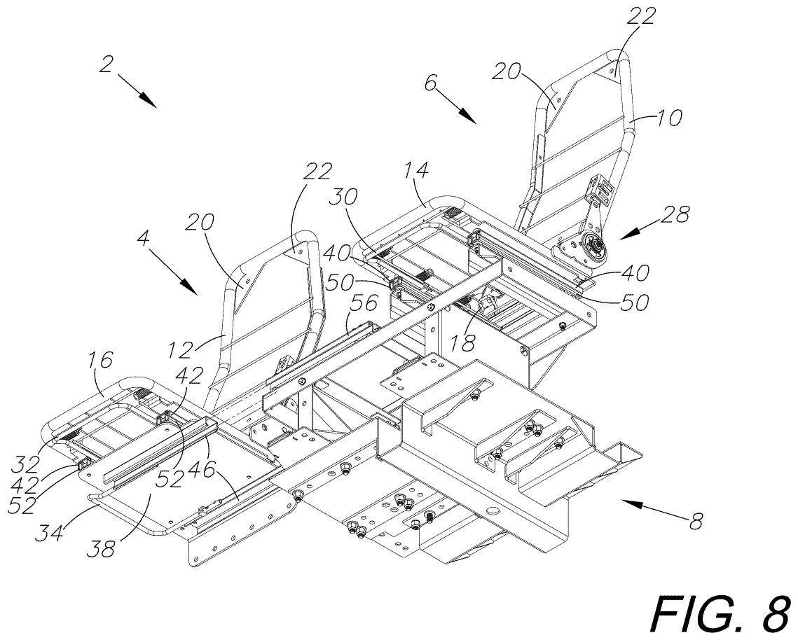

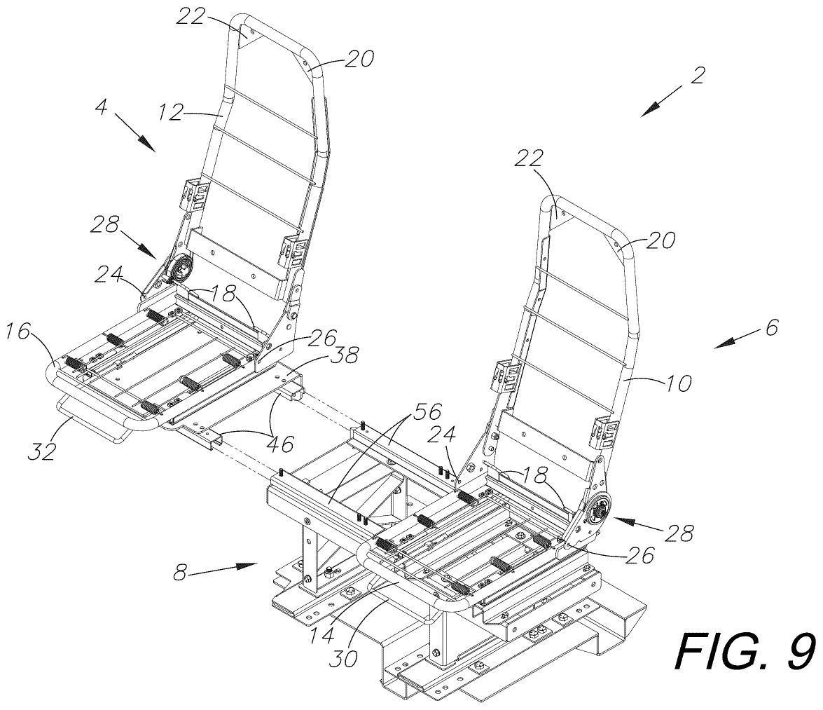

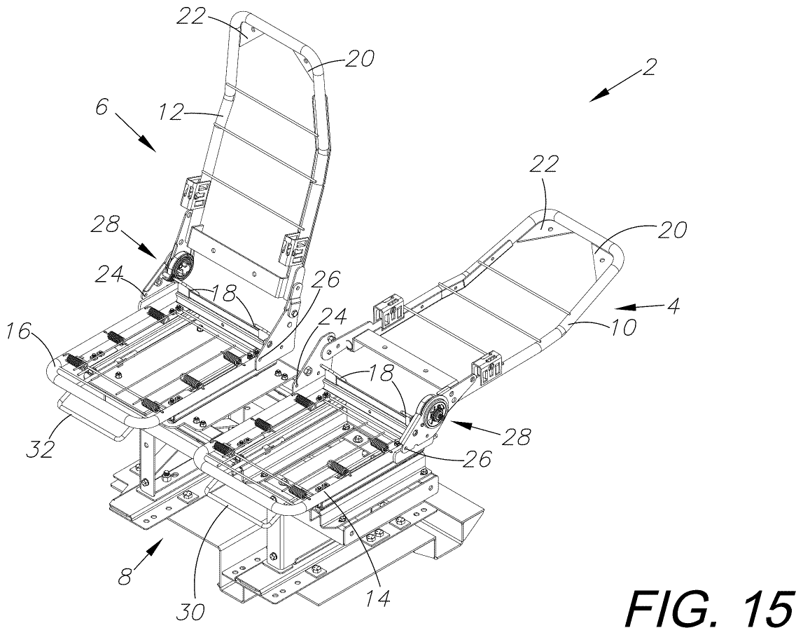

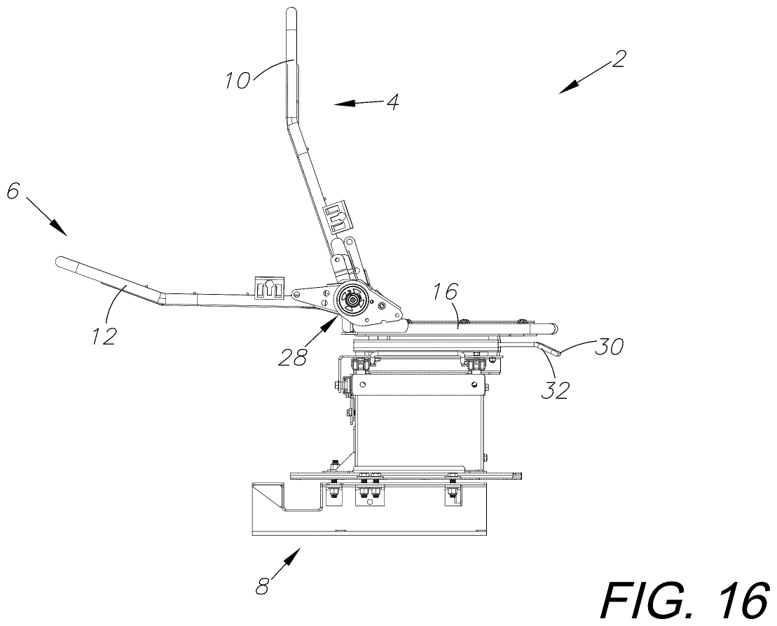

As shown in FIGS. 1-17, the present invention shows a bench seat system 2 which can be installed within a vehicle interior. The bench seat system 2 includes a left chair 4 and a right chair 6 which are installed together on a structural base 8 which is mounted to the vehicle interior and which can slide and/or pivot as shown by the arrows in FIGS. 1 and 2. The two chairs 4, 6 are each independently slidable forward and rearward with respect to the structural base 8 they are installed upon and with respect to one another. The exterior chair, which is the right seat 6 when oriented facing forward in the vehicle, may also slide out and away from the interior (left) chair 4 which is located closest to the vehicle wall. In FIGS. 1-6, these chairs 4, 6 are shown in a first, upright and adjacent orientation.

The left chair 4 includes a left seat back 10 and a left chair seat 14, while the right chair 6 includes a right seat back 12 and right seat 16. Each of the chairs 4, 6 incorporates integrated 3-point anchors seatbelts. An upper right anchor point 20 and upper left anchor point 22 provide the ability for the belt to cross either direction. One of the two upper right 20 and left 22 anchor points would be used in conjunction with a lower right anchor point 24 and a lower left anchor point 26.

Each of the chairs 4, 6, includes integrated child seat restraints 18 which are rigidly affixed to the structural frame of the seats. These and the anchors are integrated into the frame, thereby strengthening the frame while simultaneously ensuring the anchor points are even stronger.

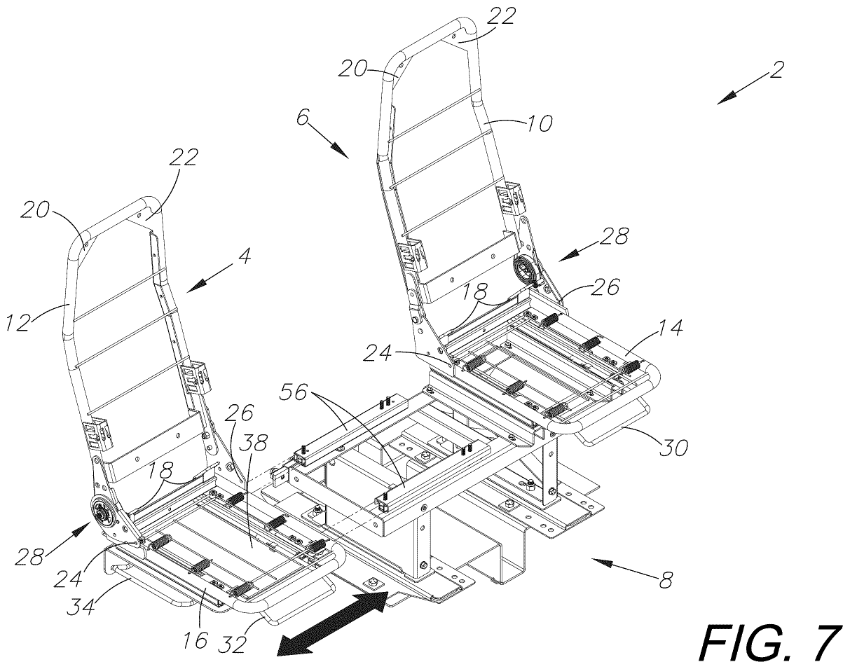

As shown in more detail in FIGS. 7-9, the right chair 6 is capable of sliding horizontally away from the left chair 4, or to slide horizontally back toward the left chair 4 if currently positioned away. A base plate 38 includes a pair of horizontal slide rails 46 which are configured to slide along a slide base 56 affixed to the structure 8. An adjustment handle 34 located on the right side of the chair 6 seat 16 allows the seat to slide horizontally toward or away from the left chair 4 as desired by locking and unlocking the slide rail 46 about the slide base 56.

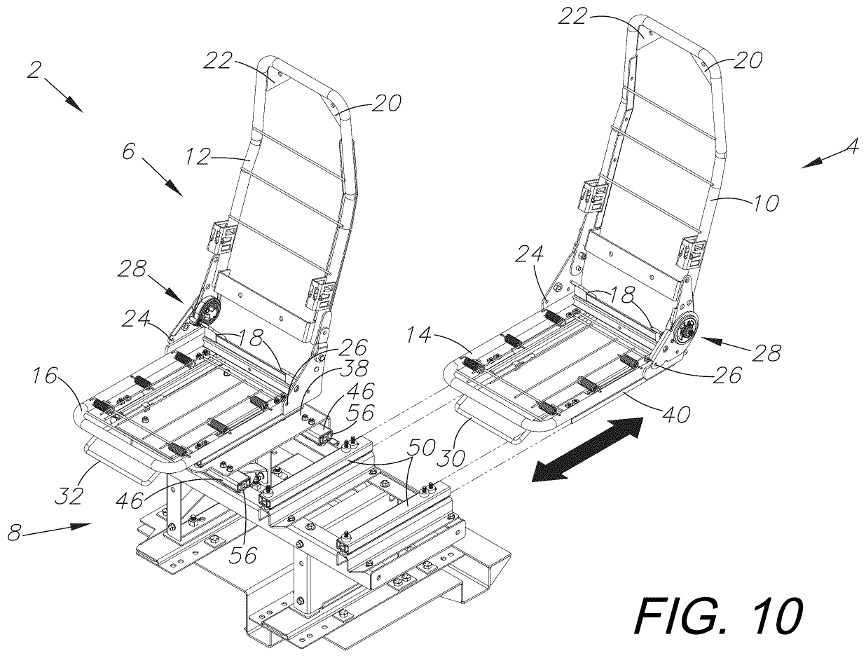

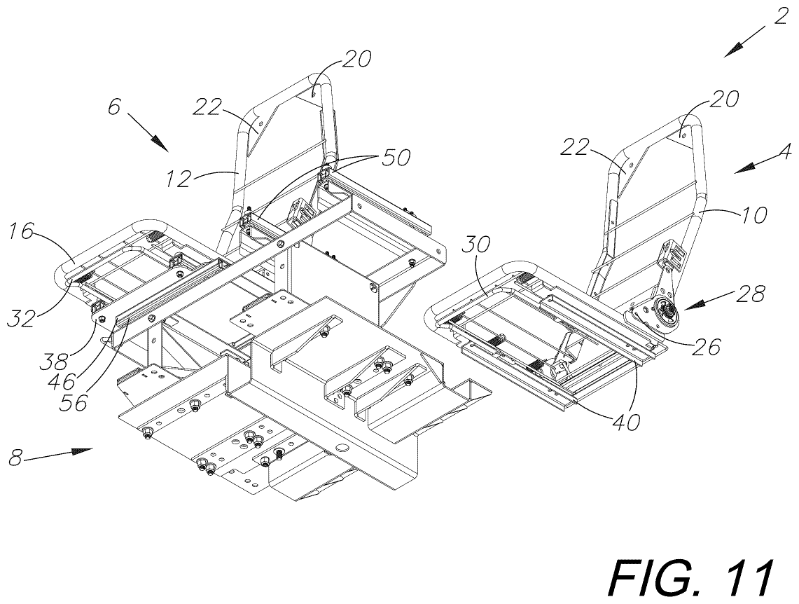

As shown in more detail in FIGS. 10 and 11, the left chair 4 has a slide base 50 affixed to the structure 8, and a slide rail 40 affixed to the bottom of the chair 4 seat 14. An adjustment handle 30 at the front of the left chair seat 14 allows the seat to slide forward or rearward as desired by locking and unlocking the slide rail 40 about the slide base 50.

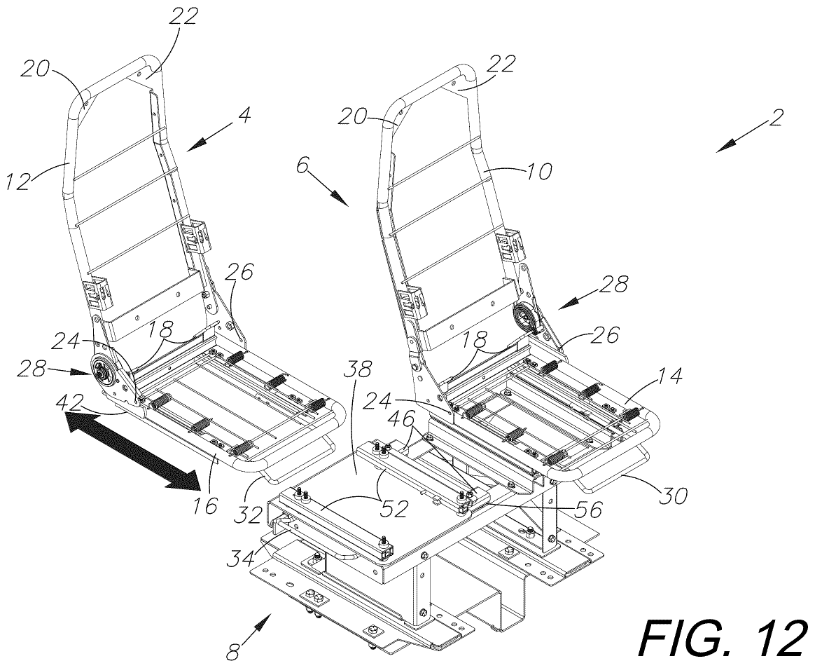

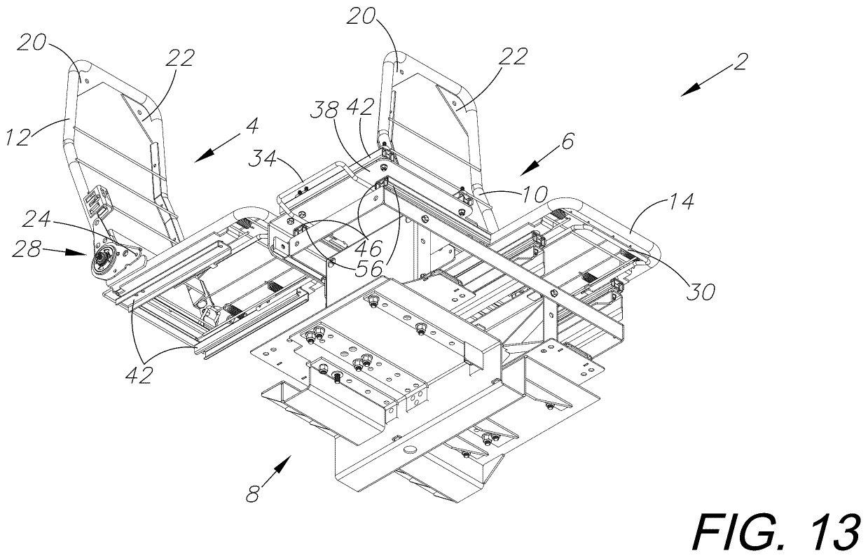

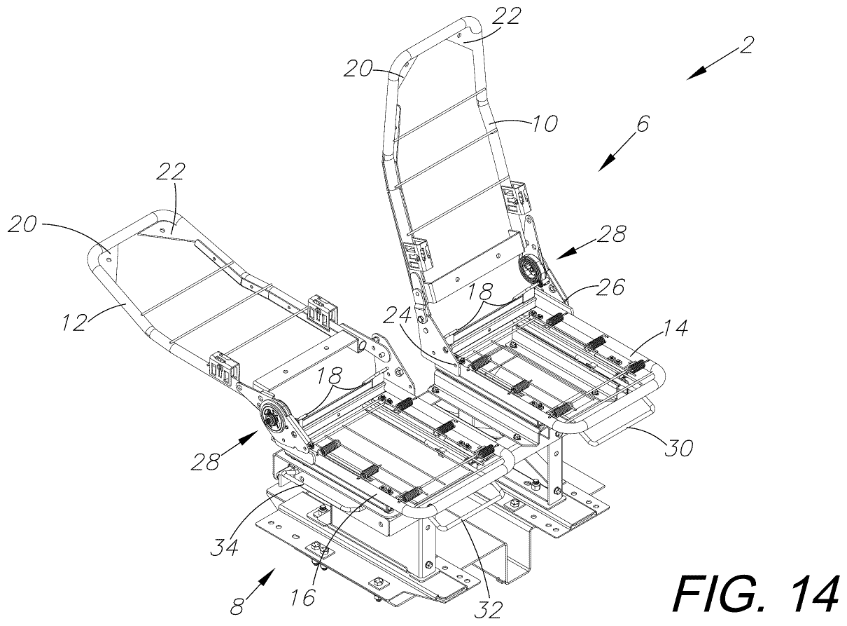

Similarly, as shown in FIGS. 12 and 13, the right chair 6 has a slide base 52 affixed to the base plate 38, and a slide rail 42 affixed to the bottom of the chair 6 seat 16. An adjustment handle 32 at the front of the left chair seat 16 allows the seat to slide forward or rearward as desired by locking and unlocking the slide rail 42 about the slide base 52.

Each chair 4, 6 includes a pivot point 28 where the respective seat back 10, 12 is configured to tilt forward or rearward, as shown in more detail in FIGS. 14-17.

The seats could be constructed at any suitable width. Typically, this would be between 15 inches and 17 inches, though any width would be suitable.

The structural elements of the seats include a base which is rigidly affixed to the floor of the vehicle.

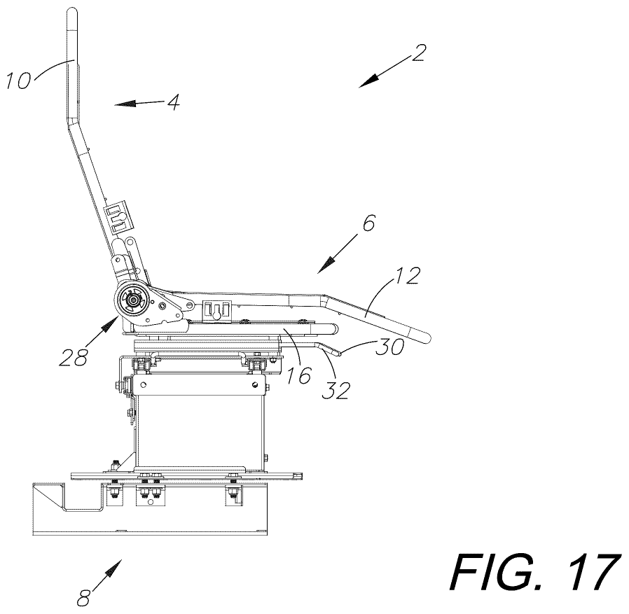

FIG. 17 shows how the seats backs 10, 12 can fold completely forward, making space for storage of large items.

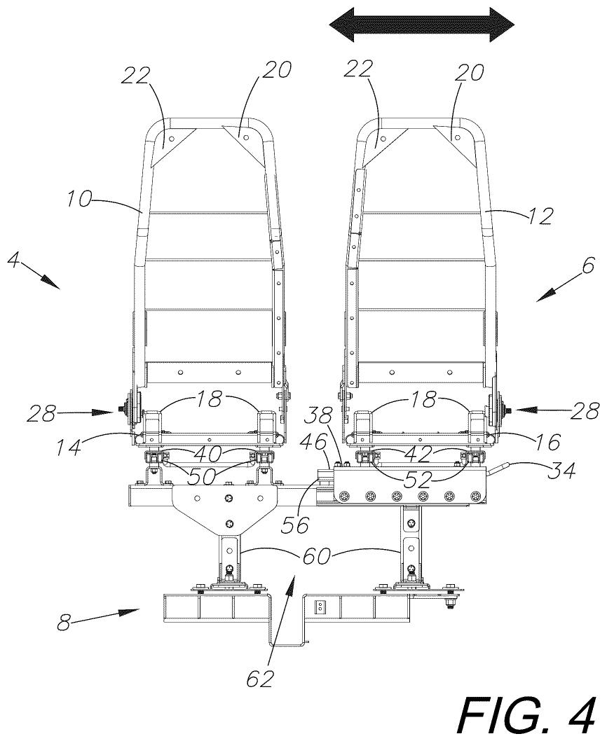

The structure beneath the seat has space 62 for storage. The structure is not solid, having two legs 60 as shown in at least FIG. 4 so that RV manufacturers can install some of their accessories in the space 62 between the legs 60, or the users can store luggage or other medium or larger items under the seat.

### III. Alternative Embodiment Bench Seat System 102

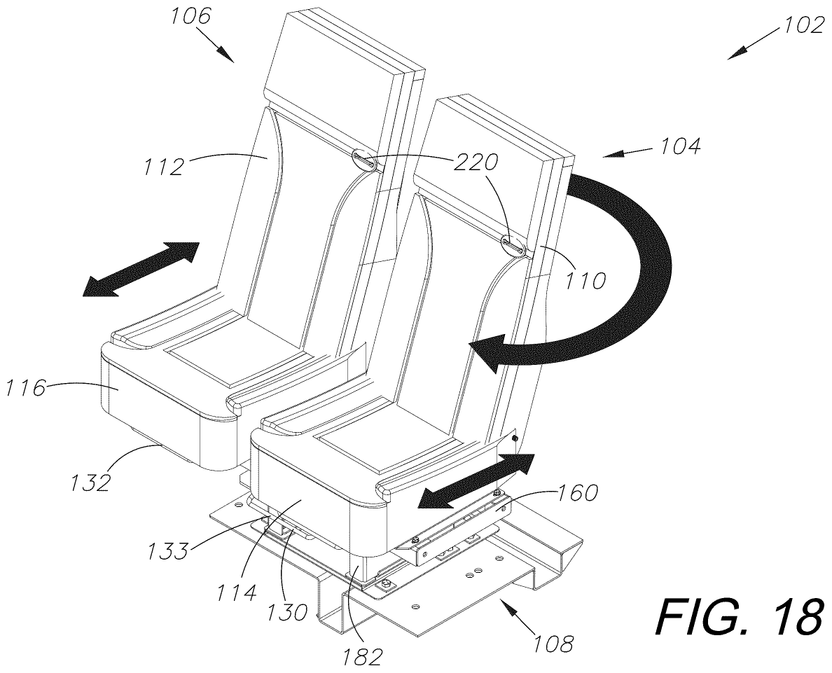

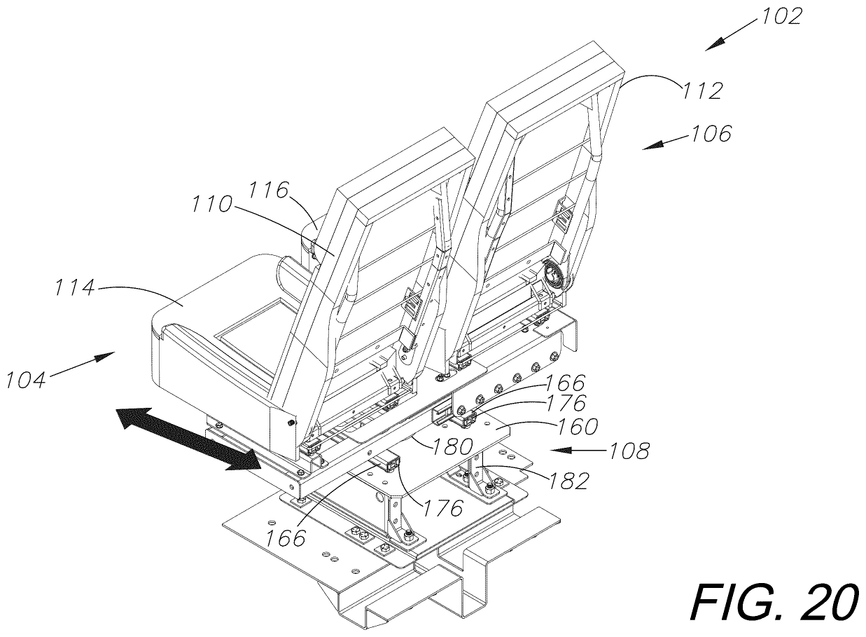

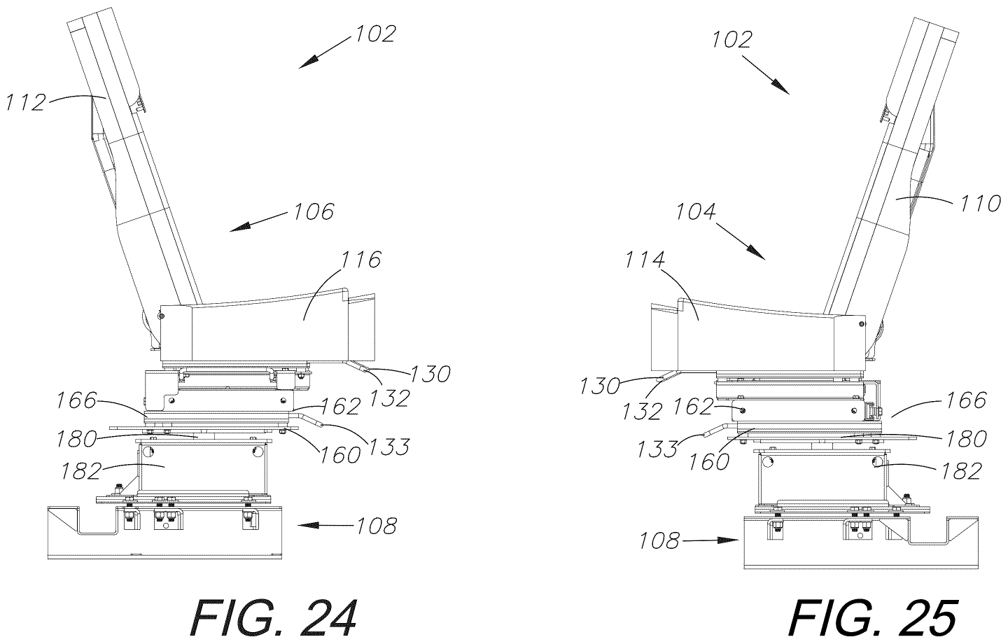

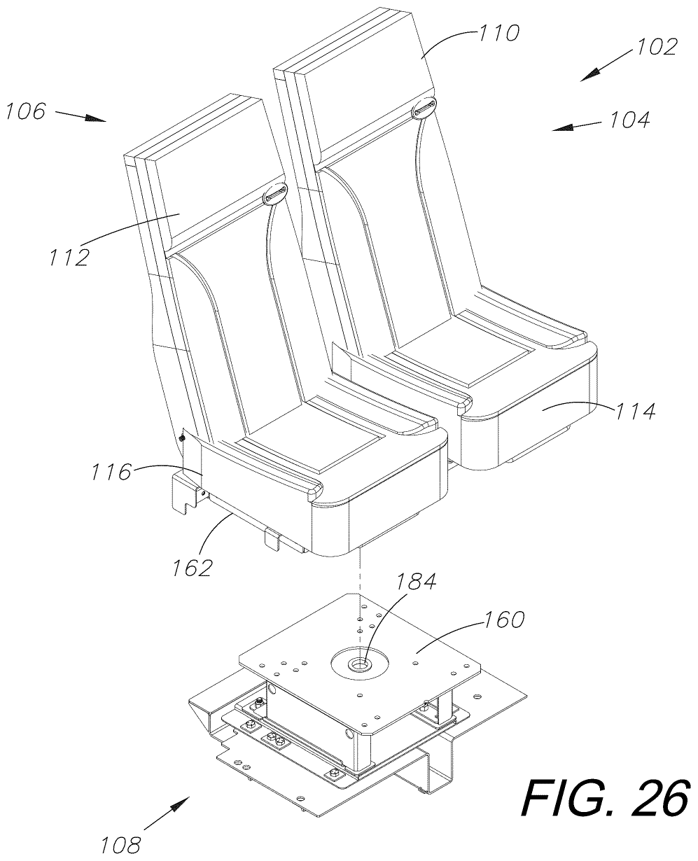

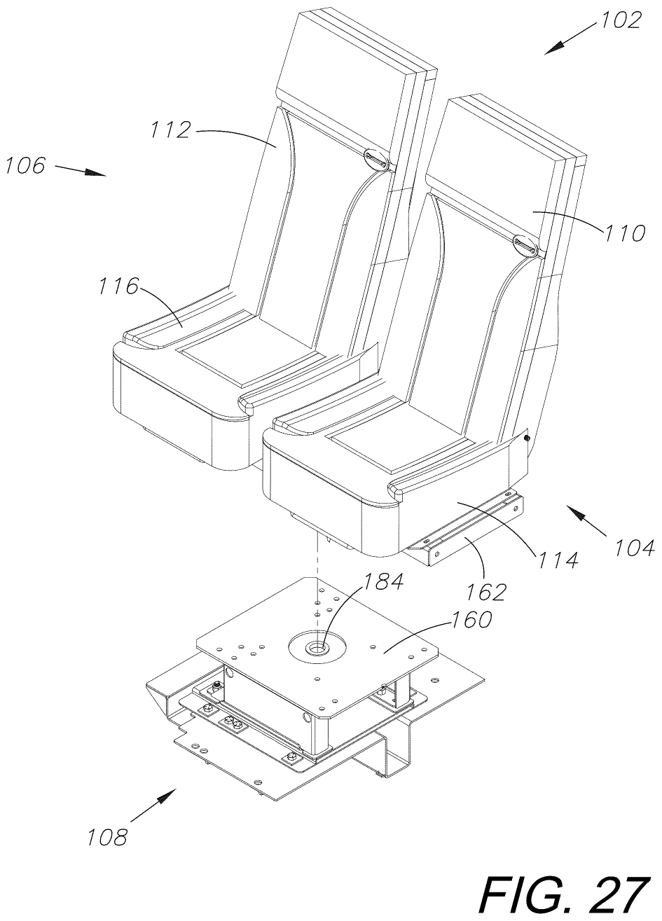

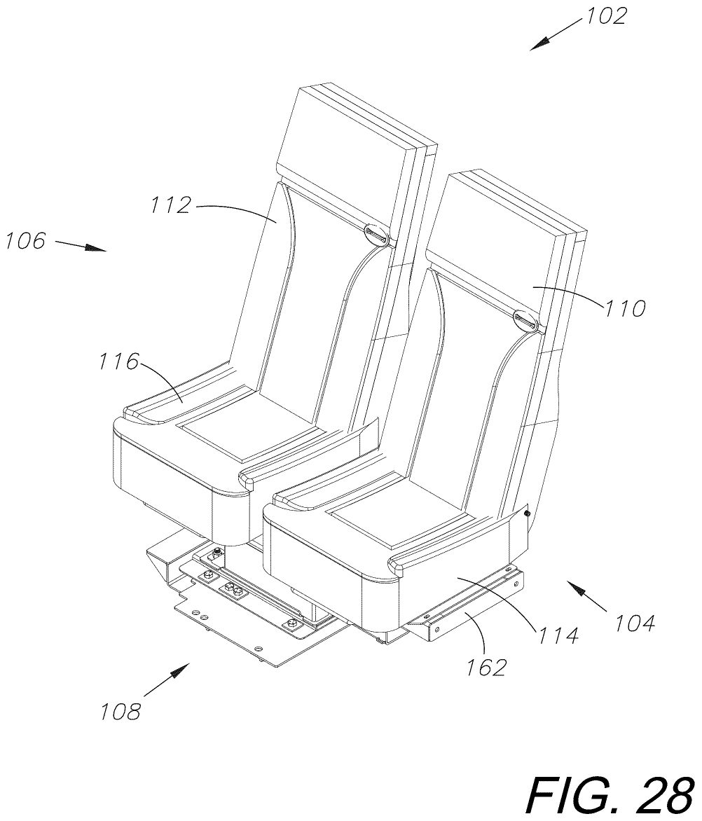

As shown in FIGS. 18-28, an alternative embodiment bench seat system 102 employs a bench seat of the above embodiment, which is placed above a rotation platform 160 which is capable of rotating the bench seat by ninety degrees (90°). The rotation platform 160 also includes slide rails 166 and slide bases 176 to allow both seats 104, 106 to slide forward and rearward simultaneously.

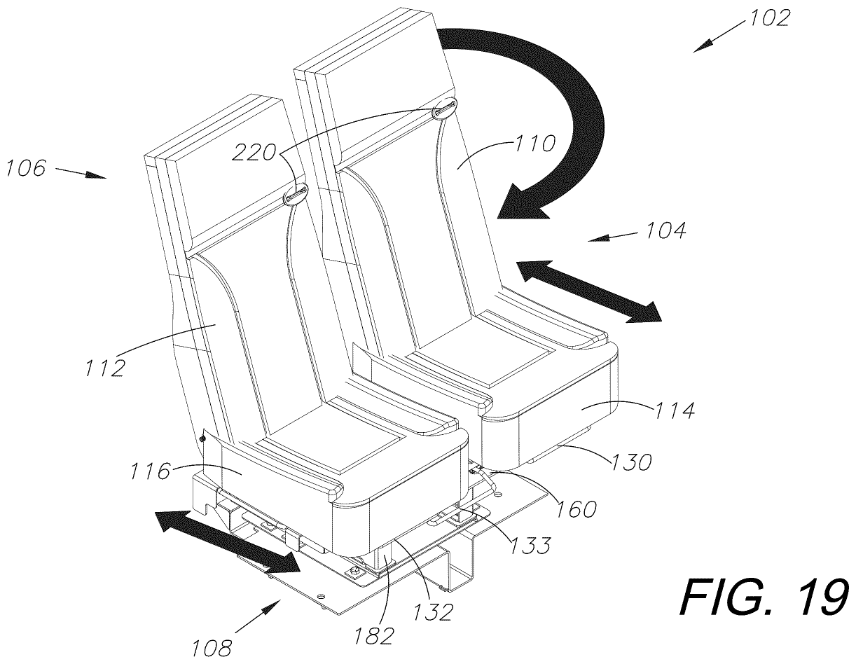

As before, the bench seat system 102 includes a left chair 104 and a right chair 106 which are installed together on a structural base 108 which is mounted to the vehicle interior and which can slide and/or pivot as shown by the arrows in FIGS. 18 and 19. The two chairs 104, 106 are each independently slidable forward and rearward with respect to a base platform 162 installed above the rotation platform 160 and the structural base 108 are installed upon and with respect to one another. The exterior chair, which is the right seat 106 when oriented facing forward in the vehicle, may also slide out and away from the interior (left) chair 104 which is located closest to the vehicle wall.

The left chair 104 includes a left seat back 110 and a left chair seat 114, while the right chair 106 includes a right seat back 112 and right seat 116. Each of the chairs 104, 106 incorporates integrated 3-point anchors seatbelts. The figures show cushions on the frame, and a shoulder belt slot 220 on each seat for receiving the upper-most anchor for the 3-point anchor seatbelt.

As with the prior embodiment, the right chair 106 is capable of sliding horizontally away from the left chair 104, or to slide horizontally back toward the left chair 4 if currently positioned away. The slide rails, slide bases, and adjustment handles, including the front adjustment handles 130, 132, are identical to the previous embodiment.

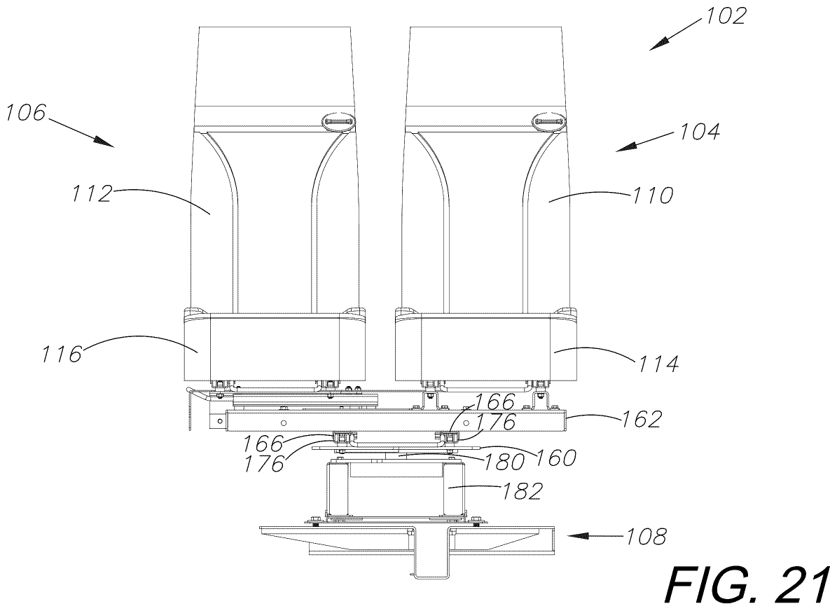

As shown in FIG. 21, a central pillar 180 acts as a pivot point about which the pair of seats can spin about the rotation platform 160. A rotation platform base 182 mounts to the structural base 108.

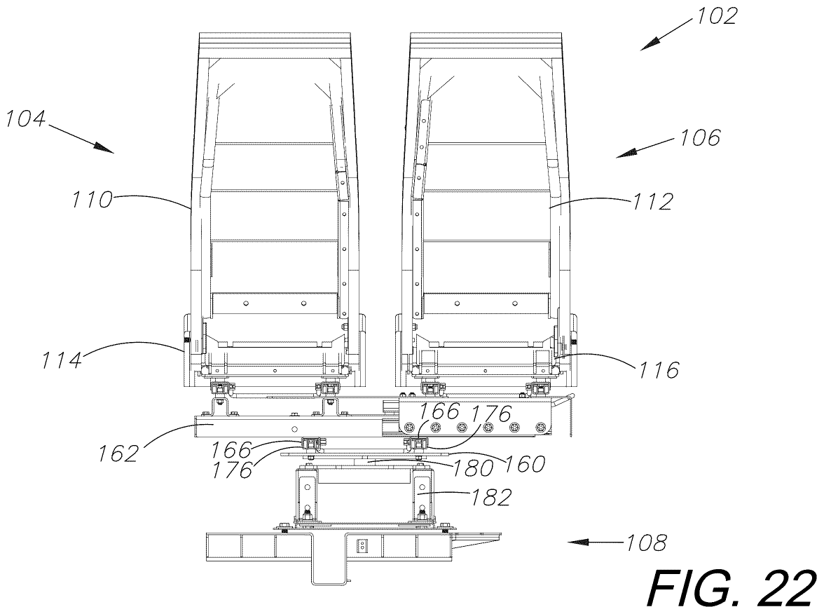

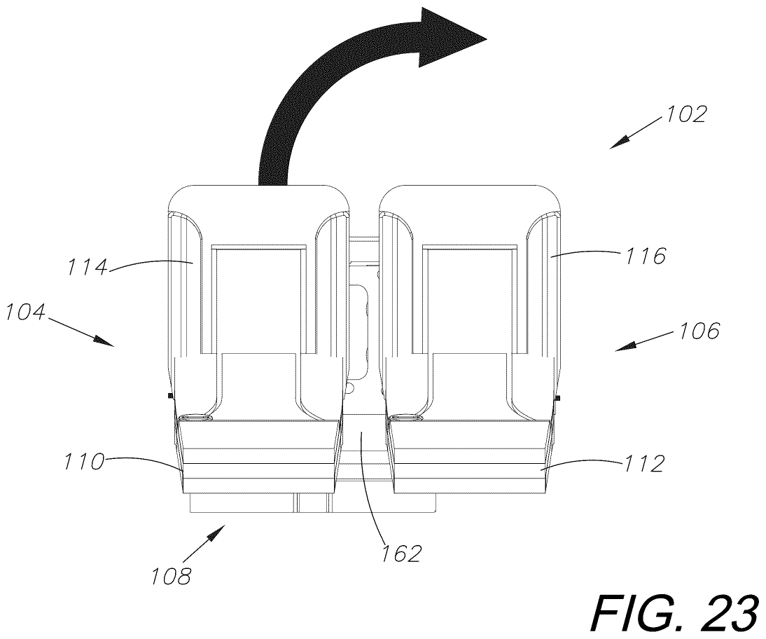

FIGS. 22 and 23 show how the central pillar 180 can slot into a pillar slot 184 of the rotation platform 160, and how the pair of chairs 104, 106 can, together, rotate about the central pillar 180 such that the two chairs 104, 106 face to the right with respect to the original forward-facing orientation.

All embodiments of the present invention could be manually operated via the various adjustment handles and other suitable manual controls. This includes the first 40, 50, second 42, 52, and third 46, 56 pairs of slides of the first embodiment, the fourth pair of slides 166, 176 of the second embodiment, and the rotation platform 160 via the central pillar 180 being operated using manual means. Each of those elements could also be controlled using power, such as via an electric motor controlled by a controller device which may be located in proximity to the chairs 4, 6, 104, 106.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A bench seat system for a vehicle interior, the system comprising:
a first chair and a second chair placed adjacent to one another, where said first chair is adjacent to a wall of said vehicle interior;
said first chair comprising a first seat frame including a first set of child safety latch anchors;
said second chair comprising a second seat frame including a second set of child safety latch anchors;
a base frame affixed to a floor surface of said vehicle interior;
said first seat frame connected to said base frame via a first pair of tracks, wherein said first pair of tracks are configured to adjust forward and rearward position of said first chair about said base frame; and
said second seat frame connected to said base frame via a second pair of tracks and a third pair of tracks, wherein said second pair of tracks are configured to adjust forward and rearward position of said second chair about said base frame, and wherein said third pair of tracks are configured to adjust a horizontal position of said second seat relative to said first seat about said base frame.

2. The bench seat system of claim 1, further comprising:
each of said first and second seats comprising a respective upper right anchor point, upper left anchor point, lower right anchor point, and lower left anchor point; and
said lower left anchor point, said lower right anchor point, and a selected one of said upper right anchor point and said upper left anchor point forming connections to a seat belt, thereby providing for a three-point anchored said seat belt.

3. The bench seat system of claim 1, wherein said first, second, and third pairs of tracks are manually operated via respective adjustment handles located on said first seat and said second seat.

4. The bench seat system of claim 1, wherein said first, second, and third pairs of tracks are power operated via an electric motor and a controller device.

5. The bench seat system of claim 1, further comprising:
said first chair mounted to a base platform via said first pair of slides and said second chair mounted to said base platform via one of said second pair of slides and said third pair of slides;
said base platform mounted to a rotation platform; and
said rotation platform pivotally mounted to a central pillar such that said rotation platform is capable of rotating on a horizontal plane relative to said floor surface of said vehicle, whereby said first and second chairs are simultaneously rotated about said central pillar.

6. The bench seat system of claim 5, wherein the rotation of said rotation platform is controlled manually.

7. The bench seat system of claim 5, wherein the rotation of said rotation platform is power operated via an electric motor and a controller device.

8. The bench seat system of claim 5, wherein said base platform is mounted to said rotation platform via a fourth pair of slides configured to slide both chairs simultaneously forward and rearward.

9. The bench seat system of claim 8, wherein said fourth pair of tracks are manually operated via an adjustment handle located in proximity to said base platform.

10. The bench seat system of claim 8, wherein said fourth pair of tracks are power operated via an electric motor and a controller device.
